(19) United States
(12) Patent Application Publication
(10) Pub. No.: US 2015/0115724 A1
(43) Pub. Date: Apr. 30, 2015

(54) WIRELESS POWER RECEIVER AND ELECTRONIC DEVICE HAVING THE SAME

(71) Applicant: SAMSUNG ELECTRO-MECHANICS CO., LTD., Suwon (KR)

(72) Inventor: Sung Heum PARK, Suwon (KR)

(73) Assignee: SAMSUNG ELECTRO-MECHANICS CO., LTD., Suwon (KR)

(21) Appl. No.: 14/146,522

(22) Filed: Jan. 2, 2014

(30) Foreign Application Priority Data
Oct. 24, 2013 (KR) 10-2013-0127323

(51) Int. Cl. H01F 38/14; H02J 5/00; H01Q 1/24

(52) U.S. Cl. CPC H01F 38/14; H01Q 1/24; H02J 5/005
USPC 307/104; 343/702

(57) ABSTRACT

There is provided a wireless power receiver, including: a frame providing an inner space; a coil pattern provided on the frame; contact terminals provided on one side of the frame and electrically connected to the coil pattern; and a magnetic sheet coupled with the frame, disposed on an upper portion of the coil pattern, and having a magnetic path formed therein, wherein the coil pattern is integrated with at least one of the frame and the magnetic sheet by insert injection molding.

### CROSS-REFERENCE TO RELATED APPLICATION

This application claims the benefit of Korean Patent Application No. 10-2013-0127323 filed on Oct. 24, 2013, with the Korean Intellectual Property Office, the disclosure of which is incorporated herein by reference.

### BACKGROUND

The present disclosure relates to a wireless power receiver capable of wirelessly receiving power by using electromagnetic induction, and an electronic device having the same.

Generally, a portable electronic device such as a mobile communication device and a personal digital assistant (PDA) is provided with a rechargeable secondary battery as a battery.

In order to charge such a battery, a separate charging device is required for supplying electrical energy to the battery in a portable electronic device using a household power source.

Typically, the charging device and the battery each have dedicated contact terminals formed on an outside thereof, such that the charging device and the battery are electrically connected to each other by connecting the contact terminals to each other.

However, if the contact terminals are protruded to the outside as described above, the contact terminals render the appearance aesthetically displeasing and may be contaminated with external foreign materials, such that a contact state therebetween easily becomes corrupted.

In addition, when the battery is short-circuited or exposed to moisture due to negligence of a user, charged energy may be easily lost.

As an alternative to the above-mentioned contact-type charging scheme, a wireless charging scheme has been proposed in which a battery is charged in such a manner that power is wirelessly transmitted without the contact terminals of the charging device and the battery coming in contact with each other.

In general, the wireless charging scheme indicates that power is transmitted wirelessly to a portable electronic device having a battery using a wireless charging device, and requires a wireless power transmitter and a wireless power receiver.

The wireless charging device and the portable electronic device transmit and receive power using electromagnetic induction. The wireless charging device and the portable electronic device are each provided with a wireless power transmitter and a wireless power receiver.

Previously, a wireless power receiver for a portable electronic device was provided on a separate case and attached to the electronic device with an adhesive, causing the electronic device to become thicker.

Therefore, in accordance with the recent trend favoring thinner devices, it is necessary to develop a thinner wireless power receiver.

### SUMMARY

An aspect of the present disclosure may provide a thin wireless power receiver by injection molding a coil pattern disposed in a wireless power receiver.

An aspect of the present disclosure may also provide a thin electronic device including the wireless power receiver.

According to an aspect of the present disclosure, a wireless power receiver may include: a frame providing an inner space; a coil pattern provided on the frame; contact terminals provided on one side of the frame and electrically connected to the coil pattern; and a magnetic sheet coupled with the frame, disposed on an upper portion of the coil pattern, and having a magnetic path formed therein, wherein the coil pattern is integrated with at least one of the frame and the magnetic sheet by insert injection molding.

The coil pattern may be integrated with the magnetic sheet by insert injection molding, and the magnetic sheet may be integrated with the frame by insert injection molding.

The coil pattern may be buried in the magnetic sheet, and a surface of the coil pattern which is not buried may contact the frame.

The coil pattern may be integrated with the frame by insert injection molding.

The coil pattern may be buried in the frame, and a surface of the coil pattern which is not buried may contact the magnetic sheet.

The coil pattern may be configured of a plurality of coil strands connected in parallel.

The magnetic sheet may contain metal magnetic flakes or ferrite powder.

The magnetic sheet and the frame may have an adhesive part interposed therebetween so as to attach the magnetic sheet to the frame.

The adhesive part may be a double-sided adhesive tape.

The coil pattern may have contact pads at an end thereof electrically connected to the contact terminals.

According to another aspect of the present disclosure, an electronic device may include: a wireless power receiver as described above; a substrate electrically connected to contact terminals of the wireless power receiver and having circuit wiring on a surface thereof; a battery electrically connected to the substrate and charged by the wireless power receiver; and a cover coupled with the wireless power receiver and accommodating the substrate and the battery.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view schematically showing an electronic device and a charging device according to an exemplary embodiment of the present disclosure;

FIG. 2 is a cross-sectional view taken along line A-A′ of FIG. 1;

FIG. 3 is an enlarged cross-sectional view of the wireless power receiver shown in FIG. 2;

FIG. 4 is an exploded perspective view of the wireless power receiver shown in FIG. 3;

FIG. 5 is a plan view of a frame according to the exemplary embodiment of the present disclosure;

FIG. 6 is an enlarged cross-sectional view of a wireless power receiver according to another exemplary embodiment of the present disclosure;

FIG. 7A is a perspective view of the wireless power receiver according to another exemplary embodiment after a coil pattern is first injection-molded;

FIG. 7B is a rear view of the wireless power receiver according to another exemplary embodiment after the coil pattern is first injection-molded; and

FIG. 8 is a perspective view of the wireless power receiver according to another exemplary embodiment after a magnetic sheet is second injection-molded.

### DETAILED DESCRIPTION

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

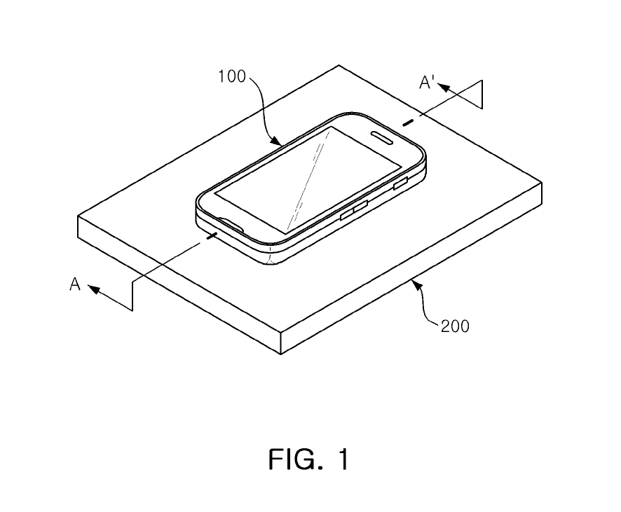

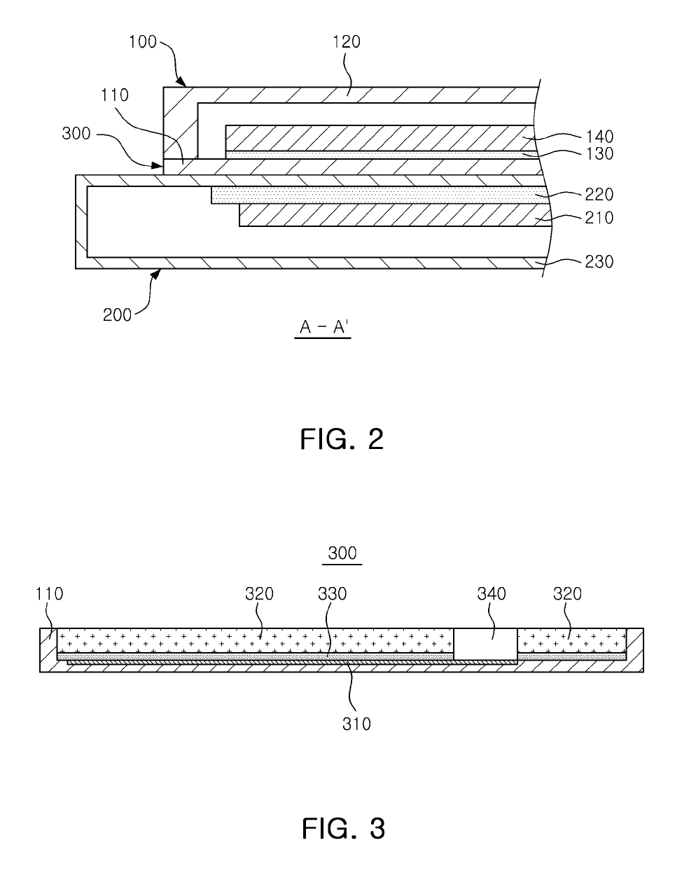

FIG. 1 is a perspective view schematically showing an electronic device and a charging device according to an exemplary embodiment of the present disclosure; and FIG. 2 is a cross-sectional view taken along line A-A′ of FIG. 1.

Referring to FIGS. 1 and 2, a charging device 200 according to the exemplary embodiment may include a wireless power transmitter 220 and a voltage converting unit 210.

The charging device 200 may serve to charge a battery 140 of an electronic device 100. To this end, the charging device 200 may include the wireless power transmitter 220 in a case 230.

The charging device 200 may include the voltage converting unit 210 to convert household AC voltage.

When voltage is applied to a coil part (not shown) of the wireless power transmitter 220, a magnetic field in the vicinity of the coil part (not shown) changes. Accordingly, the voltage induced as the magnetic field changes is applied to a wireless power receiver 300 in the electronic device 100 adjacent to the wireless power transmitter 220, such that the battery 140 is charged.

Referring to FIGS. 1 and 2, the electronic device 100 according to the exemplary embodiment may include a substrate 130, the battery 140, an upper cover 120 and the wireless power receiver 300.

The substrate 130 may be an insulating substrate such as a printed circuit board (PCB), a ceramic substrate, a pre-molded substrate or a direct bonded copper (DBC) substrate, or may be an insulated metal substrate (IMS).

In particular, the substrate 130 according to the exemplary embodiment of the present disclosure may be a flexible printed circuit board (FPCB) which is thin and has a wiring pattern formed thereon, such as a film or a thin printed circuit board.

Further, circuit wiring (not shown) may be formed on the substrate 130 through various methods including etching such as lithography, printing, depositing, and the like.

Further, at one side of the circuit wiring (not shown), an external connection terminal (not shown) may be provided.

The external connection terminal (not shown) may be electrically connected to a contact terminal 340 to transmit electromagnetically induced voltage to the battery 140.

That is, the power received by the wireless power receiver 300 may be transmitted to the battery 140 through the circuit wiring (not shown) of the substrate 130.

The battery 140 may be a rechargeable secondary battery and may be detachably connected to the electronic device 100.

Further, the battery 140 may convert electrical energy transmitted from the wireless power receiver 300 into chemical energy to store it therein and thereby supply power to the electronic device 100.

The battery 140 may be, but is not limited to, a nickel-cadmium (NiCd) battery, a lithium-ion (Li-ion) battery, a lithium-ion polymer battery, or the like.

The upper cover 120 and the wireless power receiver 300 may be coupled to create an inner space in which the substrate 130 and the battery 140 may be accommodated.

That is, the upper cover 120 and the wireless power receiver 300 may enclose the electronic device 100.

The upper cover 120 and the wireless power receiver 300 may protect the electronic device 100 from external impact and prevent external foreign materials from entering the electronic device 100.

Hereinafter, the wireless power receiver 300 included in the above-mentioned electronic device 100 will be described in more detail.

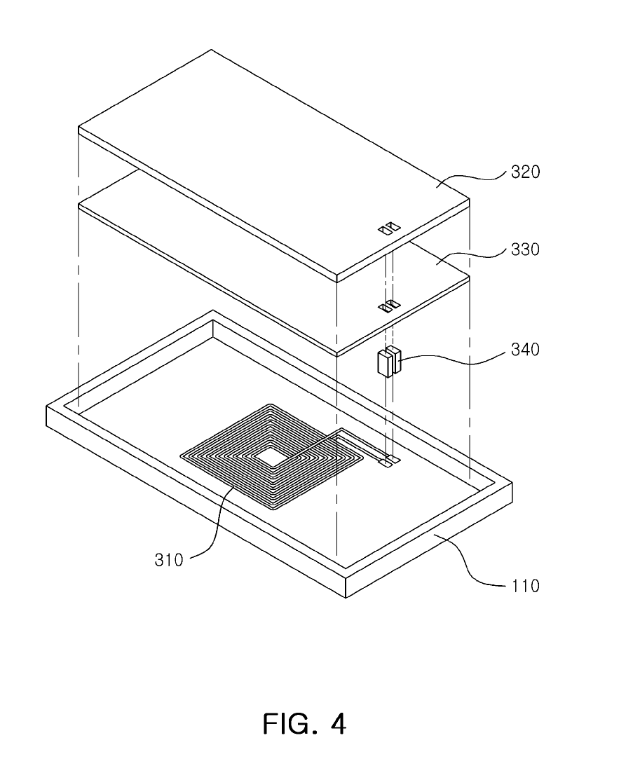

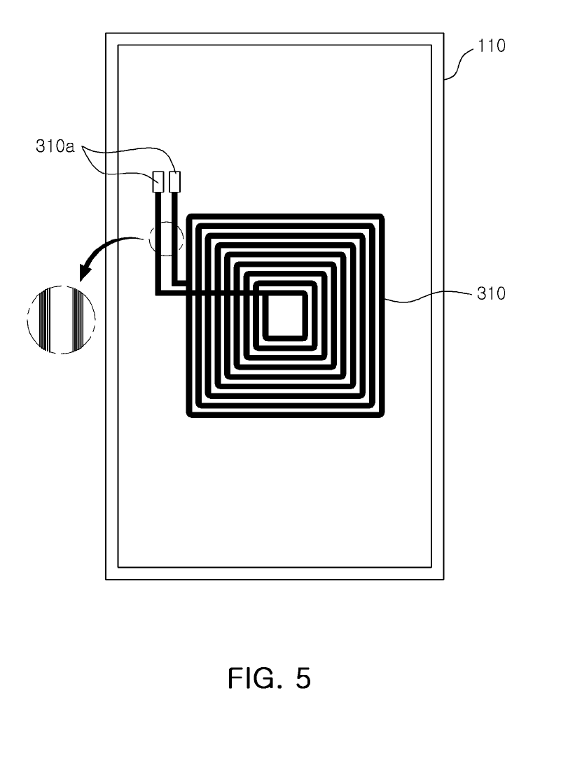

FIG. 3 is an enlarged cross-sectional view of the wireless power receiver 300 shown in FIG. 2, and FIG. 4 is an exploded perspective view of the wireless power receiver 300 shown in FIG. 3. Further, FIG. 5 is a plan view of a frame 110 according to the exemplary embodiment of the present disclosure.

Referring to FIGS. 3 through 5, the wireless power receiver 300 according to the exemplary embodiment may include the frame 110, a contact terminal 340, and a magnetic sheet 320.

The frame 110 may have an inner space and may have a coil pattern 310 on an upper portion thereof.

More specifically, the coil pattern 310 may be integrated with the frame 110 by insert injection molding. That is, the coil pattern 310 may be buried in the frame 110.

The coil pattern 310 may be insert injection molded in the magnetic sheet 320 and then insert injection molded in the frame 110, as will be described below in detail.

The resin material used in the insert injection molding of the coil pattern 310 in the frame 110 may include chlorinated polyethylene (CPE), polypropylene, ethylene propylene rubber (EDPM), polyvinyl chloride (PVC), polyimide-based resin material, and the like. Those skilled in the art may recognize that the resin material is not limited to those mentioned above, but other various resin materials also fall within the scope of the present disclosure.

After the insert injection molding, the coil pattern 310 may be exposed from one surface of the frame 110.

That is, when insert injection molding the coil pattern 310, one surface of the coil pattern 310 is closely contacted and fixed on an inner surface of a mold (not shown), such that the one surface of the coil pattern 310 closely contacted on the mold may be exposed to the outside.

Although the coil pattern 310 has a generally rectangular spiral shape in the drawings, the coil pattern 310 is not limited thereto and may have various shapes such as a circular spiral shape or a polygonal spiral shape.

Further, the coil pattern 310 may be formed of a plurality of coil strands connected in parallel and the number of the coil strands may vary depending on the size of the frame 110.

Therefore, although the coil pattern 310 is formed on the frame in a pattern, it may provide the same effect obtained when a stranded coil (for example, Litz wire) formed by twisting several strands of electrical wires is used.

When such a stranded coil is used, loss occurring due to an eddy current, a skin effect, and the like, at low frequency may be reduced.

Further, contact pads 310a may be provided at one end of the coil pattern 310. The coil pattern 310 may be electrically connected to the contact terminals 340 through the contact pads 310a.

Although the contact pads 310a may have a pad shape, it is not limited thereto and may have an elastic pin shape as necessary.

The contact terminals 340 may be provided at one side of the frame 110 and may be electrically connected to the contact pads 310a.

That is, the contact terminals 340 may be conductive members and may electrically connect the coil pattern 310 to the substrate 130.

Accordingly, by the contact terminals 340, power generated in the coil pattern 310 may be transmitted to the battery 140 through the substrate 130.

Although the contact terminals 340 have a rectangular pillar shape in the drawings, the contact terminals 340 may have a cylinder shape or polygonal pillar shape, and may have an elastic pin shape as necessary.

On an upper portion of the coil pattern 310 exposed from one surface of the frame 110, the magnetic sheet 320 having a magnetic path therein may be disposed.

That is, the magnetic sheet 320 may be provided as a flat plate (or sheet) and may be disposed on the upper portion of the coil pattern 310 and be coupled with the frame 110 such that it is disposed in the inner space of the frame 110.

Therefore, the coil pattern 310 is buried in the frame 110 and the surface of the coil pattern 310 which is not buried may come in contact with the magnetic sheet 320.

The magnetic sheet 320 is provided in order to efficiently form a magnetic path of a magnetic field generated by the coil pattern 310. To this end, the magnetic sheet 320 may be formed of a material by which the magnetic path may be easily formed, such as metal magnetic flakes or ferrite powder.

Although not shown, the magnetic sheet 320 may have a metal sheet on an outer surface thereof in order to block an electromagnetic wave or a leaked magnetic flux, if necessary.

The metal sheet may be formed of, but is not limited to, aluminum and the like.

In order to securely fix the magnetic sheet 320 to the frame 110, an adhesive part 330 may be interposed between the frame 110 and the magnetic sheet 320 so as to attach the magnetic sheet 320 to the frame.

The adhesive part 330 may attach the magnetic sheet 320 to the frame 110. The adhesive part 330 may be formed of an adhesive sheet or a double-sided adhesive tape, or may be formed by applying an adhesive or a resin having adhesive properties on a surface of the frame 110 or the magnetic sheet 320. Here, the adhesive part 330 may contain ferrite powder so that it may e magnetism along with the magnetic sheet.

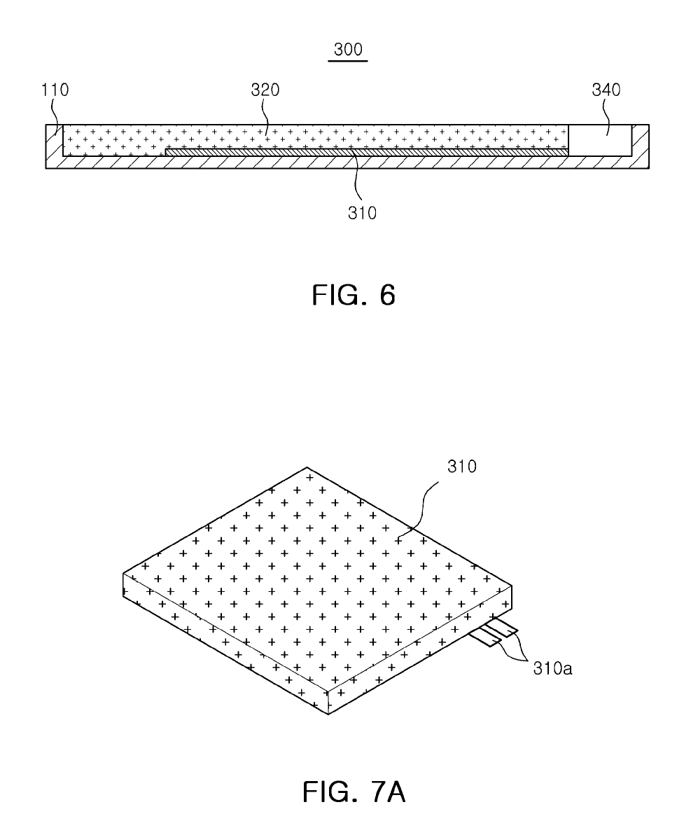

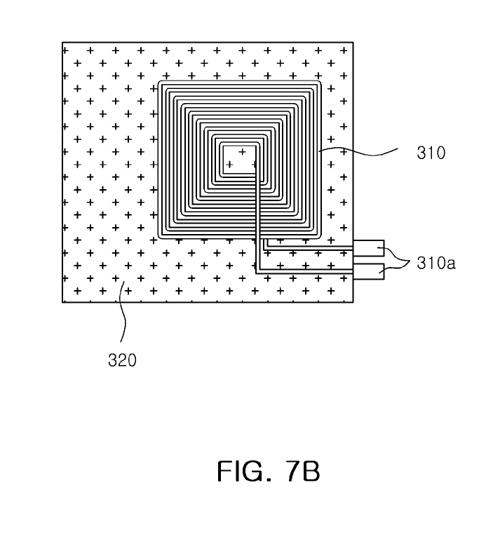

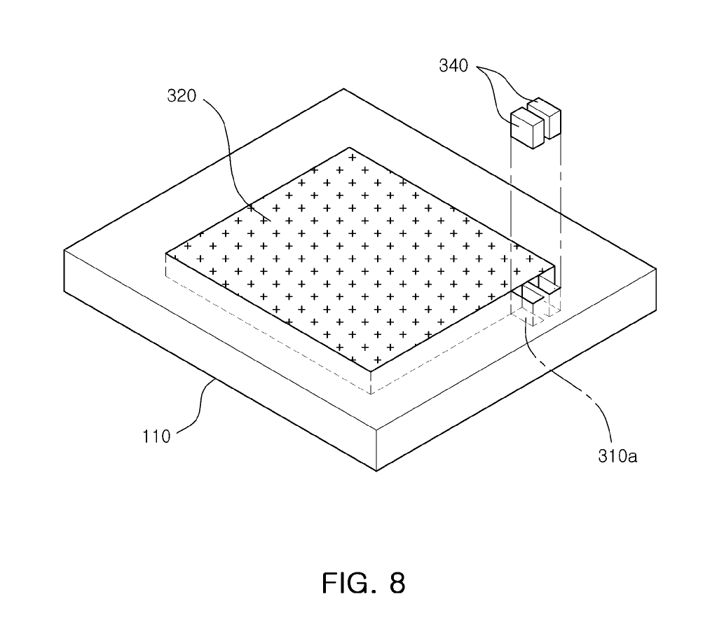

FIG. 6 is an enlarged cross-sectional view of a wireless power receiver according to another exemplary embodiment of the present disclosure, FIG. 7A is a perspective view of the wireless power receiver according to the exemplary embodiment after a coil pattern is first injection-molded, FIG. 7B is a rear view of the wireless power receiver according to the exemplary embodiment after the coil pattern is first injection-molded, and FIG. 8 is a perspective view of the wireless power receiver according to the exemplary embodiment after a magnetic sheet is second injection-molded.

Referring to FIGS. 6 to 8, the wireless power receiver according to another exemplary embodiment may include a frame 110, a coil pattern 310, a magnetic sheet 320, and contact terminals 340. Features other than those to be described hereinafter are substantially identical to those described above. Therefore, detailed descriptions on the identical features will be omitted.

The wireless power receiver according to the exemplary embodiment may include a frame 110, a coil pattern 310, a magnetic sheet 320, and contact terminals 340.

The coil pattern 310 may be integrated with the magnetic sheet 320 by insert injection molding, and the magnetic sheet 320 may be integrated with the frame by insert injection molding.

Specifically, the coil pattern 310 has one surface thereof fixed on a mold (not shown) and is insert injection-molded using a resin material containing a magnetic component, thereby forming the magnetic sheet 320 which is a first molded piece.

The coil pattern 310 may be buried in the magnetic sheet 320, and one surface of the coil pattern 310 which is in contact with the mold (not shown) may be exposed to the outside of the magnetic sheet 320 (see FIG. 7B).

Furthermore, a part or all of the contact pads 310a provided at one end of the coil pattern and electrically connected to the contact terminals 340 may be exposed to the outside of the magnetic sheet 320 (see FIG. 7B).

Then, the magnetic sheet 320 is insert injection molded using a resin material, with a surface other than the surface from which the coil pattern 310 is exposed fixed on the mold, thereby forming the frame 110 which is a second molded piece.

The surface of the coil pattern 310 which is not in contact with the mold may be in contact with the frame. Therefore, the coil pattern 310 may be buried in the magnetic sheet 320 and the surface of the coil pattern 310 which is not buried in the magnetic sheet 320 may come in contact with the frame 110.

That is, according to the exemplary embodiment of the present disclosure, the magnetic sheet which is the first molded piece may be formed by first insert injection molding, and the frame which is the second molded piece may be formed by insert injection molding the first molded piece once more.

As set forth above, according to exemplary embodiments of the present disclosure, a thickness of a wireless power receiver may be reduced by way of insert injection molding a coil pattern disposed therein.

Further, according to exemplary embodiments of the present disclosure, the thickness of an electronic device including the wireless power receiver may be reduced.

While exemplary embodiments have been shown and described above, it will be apparent to those skilled in the art that modifications and variations could be made without departing from the spirit and scope of the present disclosure as defined by the appended claims.

What is claimed is:

1. A wireless power receiver, comprising:
a frame providing an inner space;
a coil pattern provided on the frame;
contact terminals provided on one side of the frame and electrically connected to the coil pattern; and
a magnetic sheet coupled with the frame, disposed on an upper portion of the coil pattern, and having a magnetic path formed therein,
wherein the coil pattern is integrated with at least one of the frame and the magnetic sheet by insert injection molding.

2. The wireless power receiver of claim 1, wherein the coil pattern is integrated with the magnetic sheet by insert injection molding, and the magnetic sheet is integrated with the frame by insert injection molding.

3. The wireless power receiver of claim 2, wherein the coil pattern is buried in the magnetic sheet, and a surface of the coil pattern which is not buried contacts the frame.

4. The wireless power receiver of claim 1, wherein the coil pattern is integrated with the frame by insert injection molding.

5. The wireless power receiver of claim 4, wherein the coil pattern is buried in the frame, and a surface of the coil pattern which is not buried contacts the magnetic sheet.

6. The wireless power receiver of claim 1, wherein the coil pattern is configured of a plurality of coil strands connected in parallel.

7. The wireless power receiver of claim 1, wherein the magnetic sheet contains metal magnetic flakes or ferrite powder.

8. The wireless power receiver of claim 1, wherein the magnetic sheet and the frame has an adhesive part interposed therebetween so as to attach the magnetic sheet to the frame.

9. The wireless power receiver of claim 8, wherein the adhesive part is a double-sided adhesive tape.

10. The wireless power receiver of claim 1, wherein the coil pattern has contact pads at an end thereof electrically connected to the contact terminals.

11. An electronic device, comprising:
a wireless power receiver of claim 1;
a substrate electrically connected to contact terminals of the wireless power receiver and having circuit wiring on a surface thereof;
a battery electrically connected to the substrate and charged by the wireless power receiver; and
a cover coupled with the wireless power receiver and accommodating the substrate and the battery.
